(19) United States
(12) Patent Application Publication
(10) Pub. No.: US 2022/0225271 A1
(43) Pub. Date: Jul. 14, 2022

(54) METHODS FOR ENABLING DOWNLINK DATA COMMUNICATION BETWEEN A WIRELESS DEVICE AND A NETWORK NODE, WIRELESS DEVICES AND NETWORK NODES

(71) Applicant: Sony Group Corporation, Tokyo (JP)

(72) Inventors: Rickard LJUNG, Helsingborg (SE); Basuki PRIYANTO, Lund (SE); Anders BERGGREN, Lund (SE); Nafiseh MAZLOUM, Lund (SE)

(21) Appl. No.: 17/613,052

(22) PCT Filed: May 15, 2020
(86) PCT No.: PCT/EP2020/063700

§ 371 Date: Nov. 20, 2021

(30) Foreign Application Priority Data
Jun. 17, 2019 (SE) 1950731-8

(51) Int. Cl. H04W 68/02

(52) U.S. Cl. CPC H04W 68/02

(57) ABSTRACT

The method is performed by a wireless device, for enabling downlink data communication between the wireless device and a network node. The wireless device is in idle mode. The method comprises communicating, between the wireless device and the network node, control signalling identifying a time parameter indicative of a downlink data reception opportunity associated with a preconfigured uplink resource. The time parameter is indicative of a paging window. The method comprises monitoring the paging window for paging messages. The method comprises upon receiving a paging message in the paging window, receiving downlink data in accordance with the paging message from the network node.

The present disclosure pertains to the field of wireless communications. The present disclosure relates to methods for enabling downlink data communication between a wireless device and a network node, wireless devices and network nodes.

### BACKGROUND

The 3rd Generation Partnership Project (3GPP) Radio Access Network (e.g. RAN1 and RAN2) groups work on specifying the use of preconfigured uplink resources (PUR). This for example applies to the scenario where a wireless device is repeatedly transmitting small uplink data transmissions with a known time interval in between the transmissions. The wireless device may ask a network node for such allocation of PUR, and the network node can configure the repeated future uplink (UL) allocation(s) via Radio Resource Control (RRC) control signaling. When such transmission on PUR occurs, the wireless device can transmit a small payload using the preconfigured uplink resources. In this scenario, the wireless device remains in an RRC idle state or similar, while communicating on the uplink using the PUR. In practice, small payload may be transmitted in a transport block size of 1000 bits or even less.

However, there is room for improving a downlink communication for the wireless device configured to transmit on PUR in idle mode.

### SUMMARY

For example, the network node may expect to send to the wireless device a downlink data response of the uplink data (transmitted on PUR). However, such downlink data transmission may suffer from a large delay, e.g. dependent on the behavior of the application server which may reside on the Internet, and on the power saving mechanism in which the wireless device may not be reachable in certain periods such as power saving mode (PSM), mobile initiated connection only (MICO) mode, or (extended) discontinuous reception (DRX) implemented in the wireless device.

Accordingly, there is a need for devices and methods for enabling downlink data communication, which mitigate, alleviate or address the shortcomings presented and provides a control of downlink signalling for providing a downlink data reception opportunity which is earlier than in the existing techniques.

The present disclosure provides a method, performed by a wireless device, for enabling downlink data communication between the wireless device and a network node. The wireless device is in idle mode. The method comprises communicating, between the wireless device and the network node, control signalling identifying a time parameter indicative of a downlink data reception opportunity associated with a preconfigured uplink resource. The time parameter is indicative of a paging window. The method comprises monitoring the paging window for paging messages. The method comprises upon receiving a paging message in the paging window, receiving downlink data in accordance with the paging message from the network node.

Further, a wireless device is provided, the device comprising: a memory circuitry, a processor circuitry, and a wireless interface. The wireless device is configured to perform any of the methods disclosed herein.

The disclosed wireless device can advantageously indicate to the network node a time parameter indicative of a downlink data reception opportunity where the wireless device expects an application layer data reception related to the preconfigured uplink resource transmission. In this way, a wireless device in idle mode can receive the downlink data earlier than a preconfigured DRX period or if the device is configured to operate in PSM or MICO mode. Earlier downlink data reception may be beneficial to provide a required/adequate response time for certain applications.

The present disclosure provides a method, performed by a network node, for controlling downlink data communication between the network node and a wireless device. The method comprises communicating, between the network node and the wireless device, control signalling identifying a time parameter indicative of a downlink data reception opportunity associated with a preconfigured uplink resource. The time parameter is indicative of a paging window. The method comprises determining one or more additional paging opportunities. The method optionally comprises upon receiving downlink data from an external device, transmitting a paging message in the paging window. The method optionally comprises transmitting to the wireless device, downlink data in accordance with the paging message.

Further, a network node comprising a memory circuitry, a processor circuitry, and a wireless interface is disclosed. The network node is configured to perform any of the methods disclosed herein.

It is an advantage of the present disclosure that the network node is capable of controlling timing of downlink data communication between the network node and a wireless device based on control signalling from the wireless device. This way, the disclosed network node can schedule the paging of the wireless device earlier than with existing standards, based on the control signalling disclosed herein.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1A is a diagram illustrating an exemplary wireless communication system comprising an exemplary network node and an exemplary wireless device according to this disclosure,

FIG. 1B is a diagram illustrating an example time line for an example disclosed method,

FIG. 1C is a diagram illustrating an example time line for an example disclosed method,

FIG. 2 is a flow-chart illustrating an exemplary method, performed in a wireless device, for a low-latency resumption of a data communication with a network node of a wireless communication system according to this disclosure,

FIG. 3 is a flow-chart illustrating an exemplary method, performed in a network node of a wireless communication system, for a low-latency resumption of a data communication with a wireless device according to this disclosure,

FIG. 4 is a block diagram illustrating an exemplary wireless device according to this disclosure,

FIG. 5 is a block diagram illustrating an exemplary network node according to this disclosure, and

FIGS. 6A-B are signalling diagrams illustrating exemplary signalling between an exemplary network node and an exemplary wireless device according to the present disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

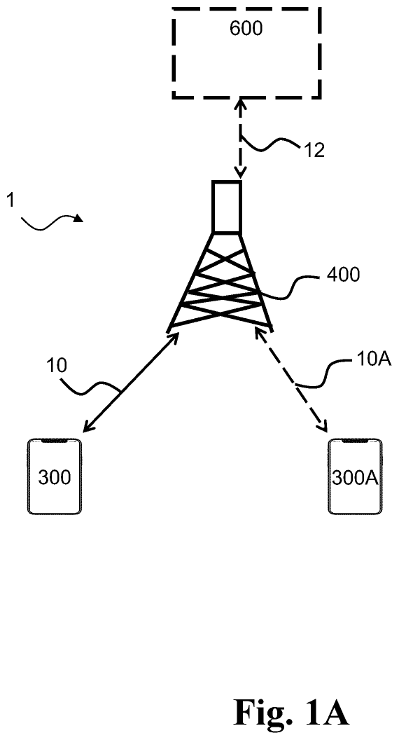

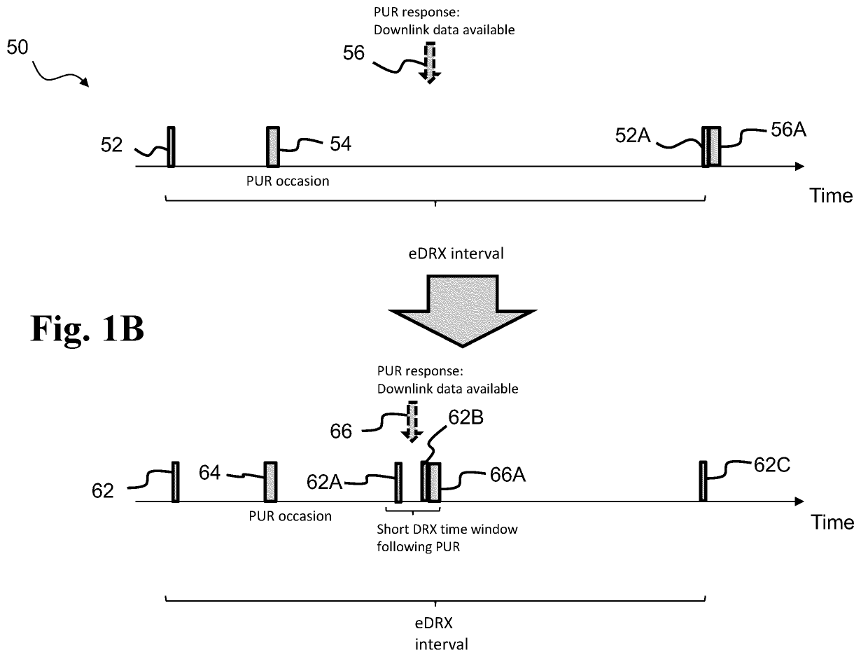

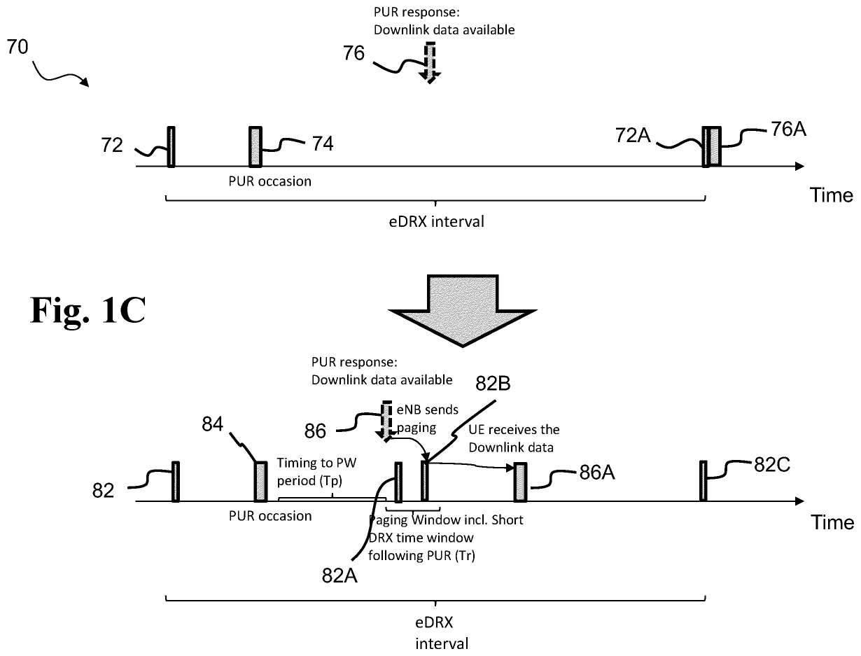

FIG. 1A is a diagram illustrating an exemplary wireless communication system 1 comprising an exemplary network node 400 and an exemplary wireless device 300 according to this disclosure.

The present disclosure relates to a wireless communication system 1 comprising a cellular system, e.g. a 3GPP wireless communication system. The wireless communication system 1 comprises a wireless device 300 and/or a network node 400.

A network node disclosed herein refers to a radio access network node operating in the radio access network, such as a base station, an evolved Node B, eNB, gNB.

The wireless communication system 1 described herein may comprise one or more wireless devices 300, 300A, and/or one or more network nodes 400, such as one or more of: a base station, an eNB, a gNB and/or an access point.

A wireless device may refer to as a mobile device and/or a user equipment, UE.

The wireless device 300, 300A may be configured to communicate with the network node 400 via a wireless link (or radio access link) 10, 10A. The wireless device 300, 300A may be configured to communicate with an external device 600 via the network node 400 connectable to the external device 600 via link 12.

FIG. 1B is a diagram 50 illustrating an example time line to illustrate an example disclosed method.

A potential use case for this disclosure may be when a wireless device repeatedly transmits uplink data to a cloud server (e.g. every day upon a given time) and the cloud server typically responds back with a status message or similar. Due to transmission and processing delay, the response from the cloud server typically arrives to the network node for delivery to the wireless device within ˜30 seconds from the uplink data transfer.

However, during this time frame, the network node is likely to have returned the wireless device to idle mode again. From a power consumption perspective of the wireless device, it is also very likely for the network node to configure the wireless device with long eDRX interval or possibly use the wireless device in a power saving mode (PSM) or a Mobile initiated communication only (MICO) mode without paging capability, especially in scenarios where the wireless device receives downlink data from the cloud server very rarely.

In legacy techniques, in order for the wireless device to relatively quickly receive the server response information, the wireless needs to be configured with a power-consuming short (e)DRX interval in order to receive the server response within reasonable time. Otherwise, the network node needs to store the data and the wireless device needs to wait until the eDRX cycle or next uplink data transfer in PSM or MICO mode configuration as shown in upper part of diagram 50.

The upper part of the diagram 50 shows a long eDRX interval after an occasion 52 where the wireless devices listens to paging. The long eDRX interval includes an occasion 52A where the wireless device listens to paging. While the wireless device is in idle mode and in inactive part of the eDRX interval, the wireless device is configured for a PUR occasion 54 and may receive a PUR response 56 indicating that downlink data is available at the network node. The wireless device then receives the downlink data 56A after paging occasion 52A following the eDRX interval. This can be a suboptimal operation, especially for certain application that may require immediate response after PUR transmission.

The lower part of the diagram 50 shows a long eDRX interval after an occasion 62 where the wireless devices listens to paging. The long eDRX interval includes an occasion 62C where the wireless device listens to paging. While the wireless device is in idle mode and in inactive part of the long eDRX interval, the wireless device is configured for a PUR occasion 64 and a short DRX window following PUR with occasions 62A and 62B where the wireless device listens to paging. The wireless device may receive a PUR response 66 indicating that downlink data is available at the network node. The wireless device then receives the downlink data 66A after paging occasion 62B within the short DRX time window.

It may be appreciated that the wireless device disclosed herein overcomes these shortcoming and benefits from being able to configure and indicate to the network node a time parameter (e.g. a time interval after the PUR transmission, e.g. short DRX after PUR transmission, e.g. a paging window after expiry of a timer starting from the PUR transmission), where the wireless device expects a downlink data reception as a response to the uplink data transfer over PUR.

FIG. 1C is a diagram 70 illustrating an example time line to illustrate an example disclosed method.

The upper part of the diagram 70 shows a long eDRX interval after an occasion 72 where the wireless devices listens to paging. The long eDRX interval includes an occasion 72A where the wireless device listens to paging. While the wireless device is in idle mode and in inactive part of the eDRX interval, the wireless device is configured for a PUR occasion 74 and may receive a PUR response 76 indicating that downlink data is available at the network node. The wireless device then receives the downlink data 76A after paging occasion 72A following the eDRX interval, which is not time-efficient.

The present disclosure provides that the wireless device indicates via control signalling a time parameter (e.g. a preferred timer value or multiple values defining a time window after a first PUR data transmission), for downlink data reception opportunity related to PUR. The lower part of diagram 70 illustrates an exemplary embodiment of the present disclosure where upon expiry of a first timer value (Tp) indicating of a “timing-to-paging window” period, the wireless device is able to quickly receive a response to the PUR data transmission during a period of time during the paging window (e.g. prior to expiry of a second timer (Tr)).

The lower part of the diagram 70 shows a long eDRX interval after an occasion 82 where the wireless devices listens to paging. The long eDRX interval includes an occasion 82C where the wireless device listens to paging. While the wireless device is in idle mode and in inactive part of the long eDRX interval, the wireless device is configured for a PUR occasion 84 and a paging window following PUR with possible multiple occasions 82A and 82B where the wireless device listens to paging and the network node sends paging messages because downlink data is available for the wireless device. The wireless device may receive a PUR response 86 indicating that downlink data is available at the network node. The wireless device then receives the downlink data 86A after receiving paging message in occasion 82B within the short DRX time window.

For example, the first data transmission 84 is an uplink transmission using a preconfigured uplink resources when the wireless device is in idle mode.

The time parameter disclosed may be indicative of a time window, e.g. a paging window, during which a DRX configuration may be used by the wireless device. For example, the wireless device is expecting a paging message in a paging window corresponding to the short DRX time window (Tr). If there is no paging message in the paging window, the wireless device remains in idle mode. If there is a paging message received during the paging window, the wireless device can expect further downlink data 86A that may be in early data transmission (EDT) which occur during random access procedure or in connected mode.

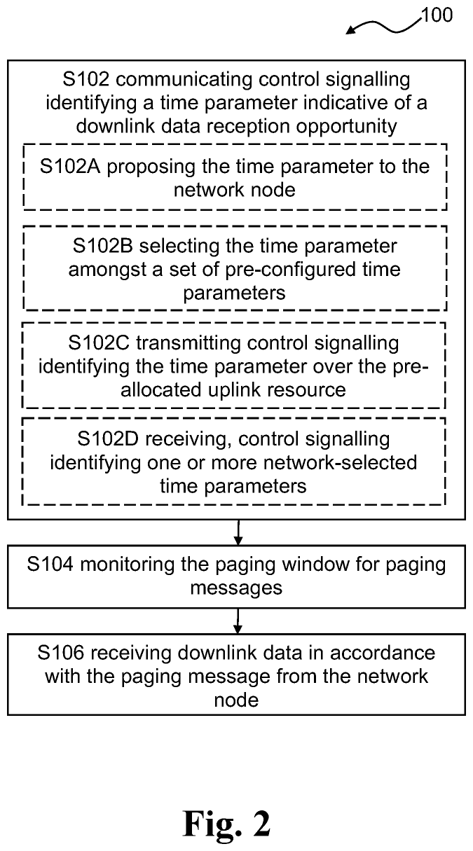

FIG. 2 shows a flow diagram of an exemplary method 100 performed by a wireless device according to the disclosure.

The method 100 is performed by a wireless device, for enabling downlink data communication between the wireless device and a network node. The wireless device is in idle mode. For example, idle mode may comprise RRC Idle mode, RRC Inactive mode, and/or RRC Suspended mode.

The method 100 comprises communicating S102, between the wireless device and the network node, control signalling identifying a time parameter indicative of a downlink data reception opportunity associated with a preconfigured uplink resource (PUR). A preconfigured uplink resource may comprise a pre-allocated uplink resource. The time parameter indicative of a downlink data reception opportunity is associated with a preconfigured uplink resource (PUR) in that it may indicate a time window which is defined with respect to the PUR occasion (e.g. starting from the end of the PUR occasion) The time parameter is indicative of a paging window. A paging window disclosed herein is a time window allocated in response to the control signalling identifying the time parameter. In other words, the paging window is not the legacy paging window. It is a newly allocated paging window. The new paging window is allocated for the purpose of communicating downlink data that is associated with a preconfigured uplink resource (PUR).

During the paging window, the wireless device monitors downlink control signalling (e.g. for an identifier such as Paging—Radio Network Temporary Identifier (P_RNTI)) for one or more possible transmissions of a paging message. A time interval may be configured to determine the time in-between the possible transmissions within the paging window. Such time interval may be the same as the DRX value configured for the cell. The paging window may occur at a specific time following a PUR transmission. The paging window may start after a time period following a PUR transmission with control signalling identifying the time parameter. The time parameter may be indicative of the time period following a PUR transmission (e.g. a timer upon which expiry the paging window starts, e.g. Tp of FIG. 1C). The time parameter may be indicative of a duration of the paging window, e.g. Tr of FIG. 1C.

The time parameter may be seen as a proposed time parameter from the wireless device.

Communicating S102 the control signalling may be performed over PUR signalling or over RRC signalling. The control signalling identifying the time parameter may be seen as control signalling indicative of the time parameter. Stated differently, the control signalling may define and/or indicate the time parameter indicative of a downlink data reception opportunity associated with a preconfigured uplink resource.

In one or more example methods, the method comprises determining, based on application layer information regarding a downlink data reception opportunity, the time parameter (e.g. a time period) related to a preconfigured uplink transmission (PUR) where the wireless device may modify its idle mode DRX configuration. For example, the modification of the DRX configuration is based on the expected result from the network.

In one or more example methods, the downlink data link reception may comprise downlink data link reception from an external device, e.g. a server device, e.g. a cloud server device. For example, the wireless device may expect a downlink data reception from a higher layer, such as an application coupled with the server device.

In one or more example methods, a downlink data reception opportunity may be associated with a preconfigured uplink resource, in that the downlink data reception opportunity may be schedule with respect to the PUR transmission, e.g. after the PUR transmission. For example, the time parameter may be indicative of a timer starting after PUR transmission and upon expiry of the timer, the paging window may start.

The method 100 comprises monitoring S104 the paging window for paging messages. The wireless device monitors PDCCH for a paging message indicating an upcoming downlink data reception while the wireless device maintains e.g. a long eDRX. Monitoring S104 the paging window may comprise monitoring PDCCH for a paging message during the paging window. Stated differently, when the paging window has elapsed, the wireless device stops monitoring PDCCH for a paging message. For example, the wireless device is required to listen for network response according to the time parameter indicative of the paging window. For example, the wireless device can be required to activate a paging window for paging monitoring. In one or more embodiments, in a paging window, there may be multiple paging occasions which the wireless device may be monitoring.

The method 100 comprises upon receiving a paging message in the paging window, receiving S106 downlink data in accordance with the paging message from the network node. For example, the downlink data may be received by the wireless device in response to data transmitted on the PUR.

For example, the wireless device indicates in PUR control signalling a preferred timer value or multiple values defining a time window after a first data transmission over PUR. For example, upon expiry of a first timer value (Tp), the wireless device starts the paging window for receiving a paging message and a corresponding downlink data (e.g. a period of time until a second time period (Tr) has expired in FIG. 1C). For example, the first data transmission is an uplink transmission using a PUR when the UE is in idle mode. The time parameter may be indicative of the paging window, which may be a time window, during which a certain DRX configuration is be used by the wireless device.

In one or more example methods, communicating S102 control signalling identifying the time parameter comprises proposing S102A the time parameter to the network node. For example, proposing S102A the time parameter may be seen as providing an assistance information (indication) from the wireless device to the network node so that the network node can provide the actual/granted time parameter. For example, the wireless device may be configured to communicate the time parameter (e.g. to indicate a preferred time parameter). For example, the negotiation of a timer value which can be done via RRC signalling, e.g. prior to PUR. For example, after a PUR configuration being performed or upon network registration, the wireless device and the network node can communicate and select a time parameter, e.g. a time configuration and DRX configuration for the possible downlink data transmission after a PUR transmission.

In one or more example methods, communicating S102 control signalling identifying the time parameter comprises selecting S102B the time parameter amongst a set of pre-configured time parameters. For example, the wireless device may have pre-configured time parameters established in RRC signalling, prior to PUR. The pre-configured time parameters may be established in RRC signalling, prior to PUR. The wireless device may select S102B the time parameter amongst a set of pre-configured time parameters based on information from the application layer on the upcoming downlink data related to the application layer. For example, the network node may (e.g. in a system information) indicate a set of possible timer values for network responses. The wireless device may then upon usage of the small data uplink transmissions (e.g. in PUR) include a preferred timer value among the available pre-configured time parameters. In practice, small payload may be transmitted in a transport block size of 1000 bits or less. For example, the wireless device may select two or more timer values, when the wireless device considers multiple data reception occasions.

Further in one or more example methods, the network node has configured a time parameter value (e.g. one single value) for the wireless device. As described, such configuration may be conducted in RRC signalling or via system information signalling. For example, the wireless device may then upon usage of the “small” data uplink transmission (e.g. in PUR) include an indicator (by control signalling identifying the disclosed time parameter) which indicates to the network that the wireless device is expected to listen for a potential downlink transmission according to the time parameter (e.g. at the preconfigured time window).

In one or more example methods, communicating S102 control signalling identifying the time parameter comprises transmitting S102C, to the network node, control signalling identifying the time parameter over the preconfigured uplink resource. For example, transmitting S102C, to the network node, control signalling identifying the time parameter over the preconfigured uplink resource may comprise transmitting to the network node, control signalling identifying a time parameter selected in S102B or proposed in S102A.

In one or more example methods, communicating S102 control signalling identifying the time parameter comprises receiving S102D, from the network node, control signalling identifying one or more network-selected time parameters. The network-selected time parameters may be determined by the network node based on the control signalling transmitted identifying the time parameter in S102C.

In one or more example methods, the control signalling indicative of the time parameter is part of a preconfigured uplink resource configuration.

In one or more example methods, the preconfigured uplink configuration is carried over system information, and/or RRC signalling.

In one or more example methods, the downlink data is received in response to control signalling and/or data communicated on the preconfigured uplink resource. For example, the data communicated on the PUR may be uplink data to a cloud server, which triggers the downlink data reception opportunity. The downlink data received may be in response to the control signalling identifying the time parameter. In other words, the downlink data may be received in response to a PUR occasion used by the wireless device for UL data transmission and/or an ack/nack message of DL message from the wireless device to the network node.

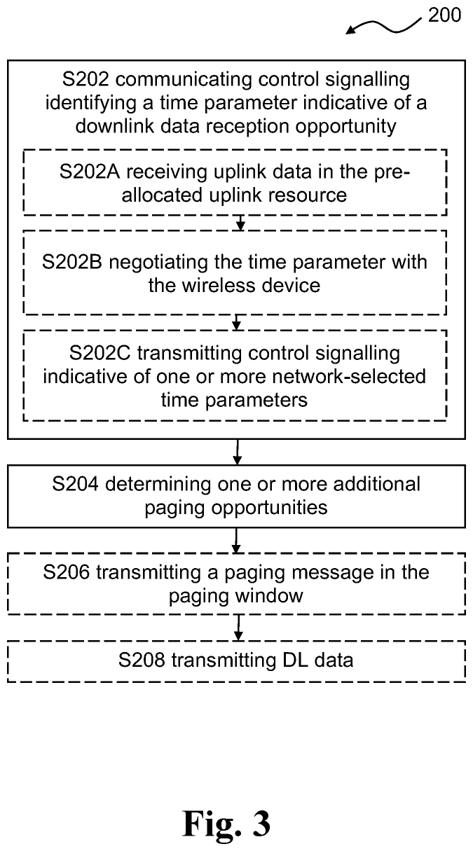

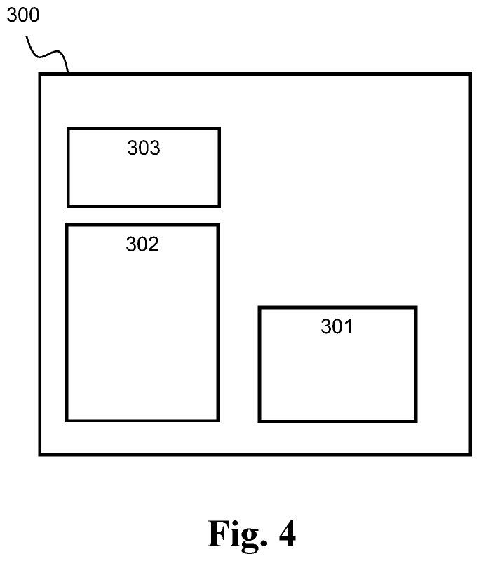

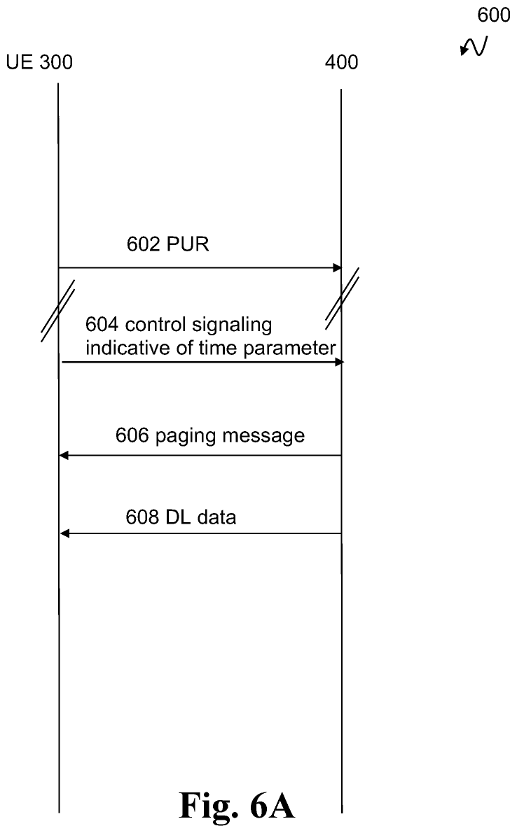

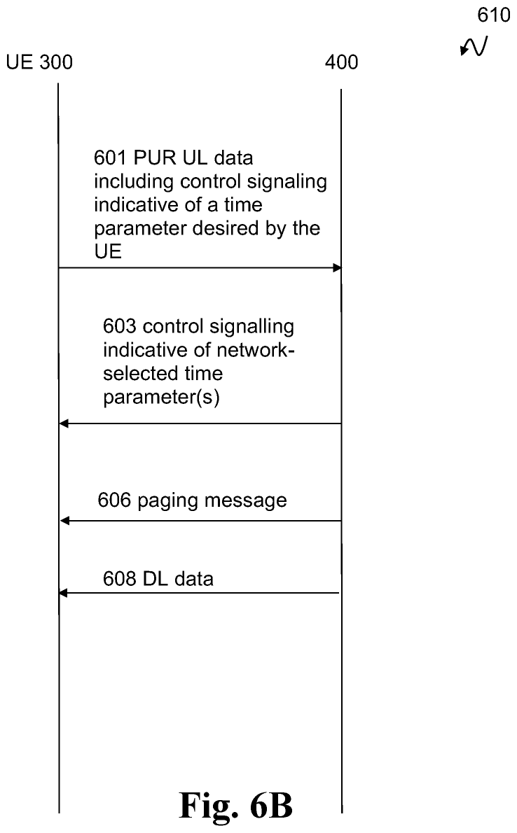

FIG. 3 shows a flow diagram of an exemplary method 200 performed by a network node according to the disclosure. The method 200 is performed by a network node, for controlling downlink data communication between the network node and a wireless device (e.g. the disclosed wireless device, wireless device 300 of FIGS. 4 and 6, e.g. the wireless device performing the method of FIG. 2). It may be envisaged that the method 200 is for controlling timing of the downlink data communication.

The method 200 comprises communicating S202, between the network node and the wireless device, control signalling identifying a time parameter indicative of a downlink data reception opportunity associated with a preconfigured uplink resource. The time parameter is indicative of a paging window. A preconfigured uplink resource may comprise a pre-allocated uplink resource.

In one or more example methods, a paging window may comprise a paging opportunity and/or paging availability. The paging window may be a one-time window or a period of DRX, for example providing one or more occasions for paging for DL reception). The paging window may comprise one or more DRX cycles.

The method 200 comprises determining S204 one or more additional paging opportunities, e.g. based on the received control signalling indicative of the time parameter. A paging opportunity is an opportunity for the network node to page the wireless device, which is determined based on the time parameter indicative of the paging window desired by the wireless device. The paging window disclosed herein is a time window allocated in response to the control signalling identifying the time parameter. In other words, the paging window is not the legacy paging window. It is a newly allocated paging window. The new paging window is allocated for the purpose of communicating downlink data that is associated with a preconfigured uplink resource (PUR) so as to schedule a downlink transmission earlier than legacy techniques.

In one or more example methods, determining S204 the one or more additional paging opportunities comprises scheduling the one or more additional paging opportunities based on the control signalling indicative of the time parameter. In one or more example methods, determining S204 the one or more additional paging opportunities comprises selecting the one or more additional paging opportunities based on the control signalling indicative of the time parameter. In one or more example methods, determining S204 the one or more additional paging opportunities comprises paging the wireless device according to the one or more additional paging opportunities e.g. by transmitting a paging message in the paging window when the downlink data is available at the network node. During the paging opportunities, the wireless device may monitor the paging window for paging messages (e.g. in S104 of FIG. 2)

The method 200 optionally comprises upon receiving downlink data from an external device, transmitting S206 one or more paging messages in the paging window. A plurality of paging messages may be transmitted to improve paging detection (in case the wireless device misses a paging message). The network node may transmit one or more paging messages in the paging window according to the one or more determined paging opportunities.

The method 200 optionally comprises transmitting S208 to the wireless device, downlink data in accordance with the paging message.

In one or more example methods, communicating S202, between the network node and the wireless device, control signalling indicative of the time parameter comprises receiving S202A, from the wireless device, uplink data in the preconfigured uplink resource, the uplink data comprising the time parameter. In one or more example methods, uplink data in the preconfigured uplink resource indicates that there is downlink data.

In one or more example methods, communicating S202 control signalling identifying the time parameter comprises negotiating S202B the time parameter with the wireless device. For example, the network node communicates (e.g. indicates the network preferred or determined time parameter corresponding to the one or more paging opportunities) the time parameter based on the received time parameter. Negotiating 5202B the time parameter with the wireless device may comprise selecting a time parameter based on the received control signalling

In one or more example methods, communicating S202 control signalling identifying the time parameter comprises transmitting S202C, to the wireless device, control signalling indicative of one or more network-selected time parameters. For example, the network node may transmit an indicator of a time parameter selected based on the received control signalling.

A set of network-selected parameters may have been signalled to the wireless device during RRC connection. The network node may signal by control signalling an indicator that points at which network selected parameter to use from e.g. the memory of the wireless device.

In one or more example methods, the control signalling indicative of a time parameter is part of a preconfigured uplink resource configuration, wherein the preconfigured uplink configuration is carried over system information, and/or RRC signalling between the wireless device and the network node.

FIG. 4 shows a block diagram of an exemplary wireless device 300 according to the disclosure. The wireless device 300 comprises a memory circuitry 301, a processor circuitry 302, and a wireless interface 303. The wireless device 300 may be configured to perform any of the methods disclosed in FIG. 2.

The wireless device 300 is configured to communicate with a network node, such as the network node disclosed herein, using a wireless communication system. The wireless interface 303 is configured for wireless communications via a wireless communication system, such as a 3GPP system, such as a 3GPP system supporting PUR.

The wireless device 300 is configured to communicate (e.g. via the wireless interface 303), between the wireless device and the network node, control signalling identifying a time parameter indicative of a downlink data reception opportunity associated with a preconfigured uplink resource. The time parameter is indicative of a paging window.

The wireless device 300 is configured to monitor (e.g. via the wireless interface 303), the paging window for paging messages.

The wireless device 300 is configured to receive (e.g. via the wireless interface 303), upon receiving a paging message in the paging window, downlink data in accordance with the paging message from the network node.

The processor circuitry 302 is optionally configured to perform any of the operations disclosed in FIG. 2 (optionally S102A, S102B, S102C, S102D of FIG. 2). The operations of the wireless device 300 may be embodied in the form of executable logic routines (e.g., lines of code, software programs, etc.) that are stored on a non-transitory computer readable medium (e.g., the memory circuitry 303) and are executed by the processor circuitry 302).

Furthermore, the operations of the wireless device 300 may be considered a method that the wireless circuitry is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 303. The memory circuitry 301 may exchange data with the processor circuitry 303 over a data bus. Control lines and an address bus between the memory circuitry 301 and the processor circuitry 303 also may be present (not shown in FIG. 4). The memory circuitry 301 is considered a non-transitory computer readable medium.

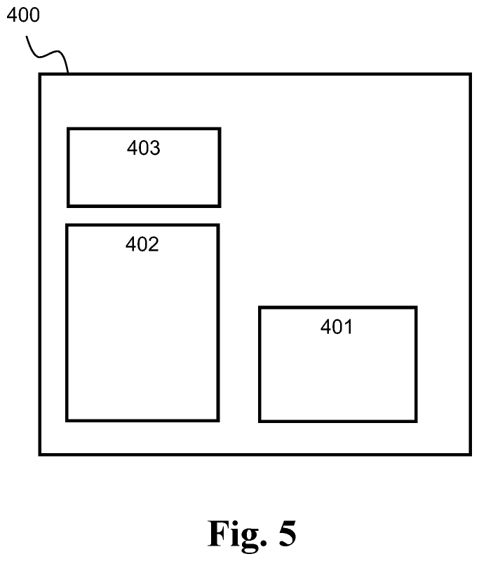

FIG. 5 shows a block diagram of an exemplary network node 400 according to the disclosure. The network node comprises a memory circuitry 401, a processor circuitry 402, and a wireless interface 403. The network node 400 is configured to perform any of the methods disclosed in FIG. 3.

The network node 400 is configured to communicate with a wireless device, such as the wireless device 300 disclosed herein, using a wireless communication system (as illustrated in FIG. 1A). The wireless interface 403 is configured for wireless communications via a wireless communication system, such as a 3GPP system, such as a 3GPP system supporting PUR signalling.

The network node 400 is configured to communicate (e.g. via the wireless interface 403), between the network node and the wireless device, control signalling identifying a time parameter indicative of a downlink data reception opportunity associated with a preconfigured uplink resource. The time parameter is indicative of a paging window.

The network node 400 is configured to determining (e.g. via the processor circuitry 402) one or more additional paging opportunities.

The network node 400 is configured to transmit (e.g. via the wireless interface 403), upon receiving downlink data from an external device, a paging message in the paging window to the wireless device.

The network node 400 is configured to transmit (e.g. via the wireless interface 403), to the wireless device, downlink data in accordance with the paging message.

The processor circuitry 402 is optionally configured to perform any of the operations disclosed in FIG. 3 (for example S202A, S202B, S202C, S206, S208 of FIG. 3). The operations of the network node 400 may be embodied in the form of executable logic routines (e.g., lines of code, software programs, etc.) that are stored on a non-transitory computer readable medium (e.g., the memory circuitry 401) and are executed by the processor circuitry 402).

Furthermore, the operations of the network node 400 may be considered a method that the wireless circuitry is configured to carry out. Also, while the described functions and operations may be implemented in software, such functionality may as well be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 5). The memory circuitry 401 is considered a non-transitory computer readable medium.

The memory circuitry 401 may be configured to store a set of predetermined configuration settings in a part of the memory circuitry 401.

FIG. 6A is a signalling diagram illustrating exemplary signalling 600 between an exemplary network node 400 and an exemplary wireless device 300 according to the present disclosure.

The wireless device, UE, 300 transmits to the network node 400 data or control signalling 602 over a preconfigured uplink resource PUR at a first PUR occasion.

For example, there may be multiple PUR transmissions occurring to transmit e.g. sensor data, regularly. Also for example, occasionally control signalling is either appended with the sensor data, or sent separately at an PUR occasion when no sensor data is available.

The wireless device 300 transmits, to the network node 400, control signalling 604 identifying the time parameter over the preconfigured uplink resource PUR, at a subsequent PUR occasion. The time parameter is indicative of a downlink data reception opportunity associated with the preconfigured uplink resource. The time parameter indicates a desired paging window. The time parameter may be selected amongst a set of pre-configured time parameters.

It may be appreciated that the control signalling is carried over a PUR transmission, and may be included in the PUR transmission 604 or in the PUR transmission 602 of the first PUR occasion.

The wireless device 300 monitors for one or more paging messages in the paging window and receives from the network node 400 a paging message 606. The wireless device 300 receives the downlink data 608 in accordance with the paging message from the network node 400.

FIG. 6B is a signalling diagram illustrating exemplary signalling 700 between an exemplary network node and an exemplary wireless device according to the present disclosure.

The wireless device, UE, 300 transmits to the network node 400 uplink data 601 over a preconfigured uplink resource PUR. The uplink data 601 comprises control signalling identifying the time parameter over the preconfigured uplink resource, where the time parameter is indicative of a downlink data reception opportunity associated with the preconfigured uplink resource. The time parameter indicates a desired paging window from the wireless device 300.

The network node 400 determines one or more additional paging opportunities based on the received control signalling and transmits to the wireless device, control signalling 603 indicative of one or more network-selected time parameters. The wireless device may then use the network-selected time parameters indicated (e.g. identified) by the control signalling 603, and which values may have been signalled during RRC connection.

The wireless device 300 monitors for one or more paging messages in the paging window derived from the network-selected parameters and receives from the network node 400 a paging message 606. The wireless device 300 receives the downlink data 608 in accordance with the paging message from the network node 400. Embodiments of methods and products (network nodes and wireless devices) according to one or more embodiments of the disclosure are set out in the following items:

Item 1. A method, performed by a wireless device, for enabling downlink data communication between the wireless device and a network node, wherein the wireless device is in idle mode, the method comprising:
communicating (S102), between the wireless device and the network node, control signalling identifying a time parameter indicative of a downlink data reception opportunity associated with a preconfigured uplink resource, wherein the time parameter is indicative of a paging window;
monitoring (S104) the paging window for paging messages, and
upon receiving a paging message in the paging window, receiving (S106) downlink data in accordance with the paging message from the network node.

Item 2. The method according to item 1, wherein communicating (S102) control signalling identifying the time parameter comprises proposing (S102A) the time parameter to the network node.

Item 3. The method according to any of the previous items, wherein communicating (S102) control signalling identifying the time parameter comprises selecting (S102B) the time parameter amongst a set of pre-configured time parameters.

Item 4. The method according to any of the previous items, wherein communicating (S102) control signalling identifying the time parameter comprises transmitting (S102C), to the network node, control signalling identifying the time parameter over the preconfigured uplink resource.

Item 5. The method according to any of the previous items, wherein communicating (S102) control signalling identifying the time parameter comprises receiving (S102D), from the network node, control signalling identifying one or more network-selected time parameters.

Item 6. The method according to any of the previous items, wherein the control signalling indicative of the time parameter is part of a preconfigured uplink resource configuration, wherein the preconfigured uplink configuration is carried over system information, and/or RRC signalling.

Item 7. The method according to any of the previous items, wherein the downlink data is received in response to control signalling and/or data communicated on the preconfigured uplink resource.

Item 8. A method, performed by a network node, for controlling downlink data communication between the network node and a wireless device, the method comprising:
communicating (S202), between the network node and the wireless device, control signalling identifying a time parameter indicative of a downlink data reception opportunity associated with a preconfigured uplink resource, wherein the time parameter is indicative of a paging window;
determining (S204) one or more additional paging opportunities;
upon receiving downlink data from an external device, transmitting (S206), to the wireless device, a paging message in the paging window; and
transmitting (S208) to the wireless device, downlink data in accordance with the paging message.

Item 9. The method according to item 8, wherein communicating (S202), between the network node and the wireless device, control signalling indicative of the time parameter comprises receiving (S202A), from the wireless device, uplink data in the preconfigured uplink resource, the uplink data comprising the time parameter.

Item 10. The method according to any of items 8-9, wherein communicating (S202) control signalling identifying the time parameter comprises negotiating (5202B) the time parameter with the wireless device.

Item 11. The method according to any of items 8-10, wherein communicating (S202) control signalling identifying the time parameter comprises transmitting (S202C), to the wireless device, control signalling indicative of one or more network-selected time parameters.

Item 12. The method according to any of items 8-11, wherein the control signalling indicative of a time parameter comprises system information part of a preconfigured uplink resource configuration, and/or RRC signalling.

Item 13. A wireless device comprising a memory circuitry, a processor circuitry, and a wireless interface, wherein the wireless device is configured to perform any of the methods according to any of items 1-7.

Item 14. A network node comprising a memory circuitry, a processor circuitry, and a wireless interface, wherein the network node is configured to perform any of the methods according to any of items 8-12.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-5 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A method, performed by a wireless device, for enabling downlink data communication between the wireless device and a network node, wherein the wireless device is in idle mode, the method comprising:
communicating, between the wireless device and the network node, control signalling identifying a time parameter indicative of a downlink data reception opportunity associated with a preconfigured uplink resource, wherein the time parameter is indicative of a paging window;
monitoring the paging window for paging messages, and
upon receiving a paging message in the paging window, receiving downlink data in accordance with the paging message from the network node.

2. The method according to claim 1, wherein communicating control signalling identifying the time parameter comprises proposing the time parameter to the network node.

3. The method according to claim 1, wherein communicating control signalling identifying the time parameter comprises selecting the time parameter amongst a set of pre-configured time parameters.

4. The method according to claim 1, wherein communicating control signalling identifying the time parameter comprises transmitting, to the network node, control signalling identifying the time parameter over the preconfigured uplink resource.

5. The method according to claim 1, wherein communicating control signalling identifying the time parameter comprises receiving, from the network node, control signalling identifying one or more network-selected time parameters.

6. The method according to claim 1, wherein the control signalling indicative of the time parameter is part of a preconfigured uplink resource configuration, wherein the preconfigured uplink configuration is carried over system information, and/or RRC signalling.

7. The method according to claim 1, wherein the downlink data is received in response to control signalling and/or data communicated on the preconfigured uplink resource.

8. A method, performed by a network node, for controlling downlink data communication between the network node and a wireless device, the method comprising:
communicating, between the network node and the wireless device, control signalling identifying a time parameter indicative of a downlink data reception opportunity associated with a preconfigured uplink resource, wherein the time parameter is indicative of a paging window;
determining one or more additional paging opportunities;
upon receiving downlink data from an external device, transmitting, to the wireless device, a paging message in the paging window; and
transmitting to the wireless device, downlink data in accordance with the paging message.

9. The method according to claim 8, wherein communicating, between the network node and the wireless device, control signalling indicative of the time parameter comprises receiving, from the wireless device, uplink data in the preconfigured uplink resource, the uplink data comprising the time parameter.

10. The method according to claim 8, wherein communicating control signalling identifying the time parameter comprises negotiating the time parameter with the wireless device.

11. The method according to claim 8, wherein communicating control signalling identifying the time parameter comprises transmitting, to the wireless device, control signalling indicative of one or more network-selected time parameters.

12. The method according to claim 8, wherein the control signalling indicative of a time parameter comprises system information part of a preconfigured uplink resource configuration, and/or RRC signalling.

13. A wireless device comprising a memory circuitry, a processor circuitry, and a wireless interface, wherein the wireless device is configured to perform the method according to claim 1.

14. A network node comprising a memory circuitry, a processor circuitry, and a wireless interface, wherein the network node is configured to perform the method according to claim 8.
